(19) United States
(12) Patent Application Publication
(10) Pub. No.: US 2025/0167495 A1
(43) Pub. Date: May 22, 2025

(54) HIGH-VOLTAGE CONTACT SYSTEM

(71) Applicant: Lisa Dräxlmaier GmbH, Vilsbiburg (DE)

(72) Inventors: Dominik PFLUMM, Muenchen (DE); Simon EGGL, Hohenthann (DE); Robert SALLER, Egglkofen (DE)

(73) Assignee: Lisa Dräxlmaier GmbH, Vilsbiburg (DE)

(21) Appl. No.: 18/949,917

(22) Filed: Nov. 15, 2024

(30) Foreign Application Priority Data
Nov. 17, 2023 (DE) 10 2023 132 156.0

(51) Int. Cl. H01R 13/66; B60L 50/60; B60L 53/16; G01K 1/16

(52) U.S. Cl. CPC H01R 13/6683; B60L 50/60; G01K 1/16; B60L 53/16

(57) ABSTRACT

A high-voltage contact system with two high-voltage contacts which form a high-voltage connection in a battery-powered vehicle. A temperature sensor is arranged between the two high-voltage contacts and is designed to record a temperature based on the temperatures of both of the two high-voltage contacts. A thermally-conductive insulating element is embedded in the temperature sensor and contacts the two high-voltage contacts. The thermally-conductive insulating element forms a thermal bridge between the two HV-contacts and the temperature sensor so that the temperature sensor can record the temperature based on the temperatures of the two high-voltage contacts.

### CROSS-REFERENCE TO RELATED APPLICATIONS

This application claims priority to and the benefit of German Patent Application No. 10 2023 132 156.0 on Nov. 17, 2023. The disclosure of the above application is incorporated herein by reference.

### FIELD

The present disclosure relates to a high-voltage (HV) contact system with two high-voltage contacts for making a high-voltage connection.

### BACKGROUND

The statements in this section merely provide background information related to the present disclosure and may not constitute prior art.

The measurement of temperatures in high-voltage plug systems or high voltage contact systems in the automobile industry helps inhibit thermal overloading of the plug system and the associated wiring. Furthermore, potential mechanical damage and/or effects of aging that can lead to elevated temperatures in plug-connector systems can be recorded and as a result, measures taken to inhibit further damage. Previous standard solutions measure the contact poles (+ or −) with one temperature sensor respectively. The use of two temperature sensors uses more installation space and results in greater complexity of the plug system, and thus higher manufacturing costs.

The monitoring of the temperature of two contacts with a common temperature sensor is known, for example, from CN 113594799 A, CN 217562844 U, US 2016/0104978 A1, JP 2002-352635 A, and JP 4 (1992)-2480 U.

### SUMMARY

This section provides a general summary of the disclosure and is not a comprehensive disclosure of its full scope or all of its features.

The present disclosure provides an improved contact system for electrically contacting the contact poles of the high-voltage battery for making a high-voltage connection, for example with a drive unit or a high-voltage battery of a battery-powered vehicle in which the temperature of the contact poles can be monitored cost-effectively and with efficient use of installation space. The present disclosure relates to techniques for temperature measurement with a temperature sensor for both direct-current contacts of a high-voltage contact system.

The present disclosure is based on the idea of using a temperature sensor that is thermally coupled to both direct-current contacts (plus and minus) with a thermally-conductive and insulating elastomer. Here, the temperature sensor can be arranged centrally between both direct-current contacts (DC+ and DC−) and enveloped in an insulating elastomer (for example overmolded or inserted) that touches on both direct-current contacts. This silicon adheres, for example, to a hard component in order to provide creepage-resistance, if desired via a 2K injection-molding process. Due to the over-pressing between the elastomer and the HV-contacts, a good thermal heat-transfer can take place, and additional heat-conducting elements, such as gap fillers (that is, material to fill air gaps) can be dispensed with. This makes it possible to reduce the complexity and cost of the sensor system and still achieve sufficiently good temperature-measurement.

The present disclosure thus leads to cost-efficient temperature measurement at the same time as it reduces installation space. In this way, the complexity of the plug-system can be reduced (or disentangled). Both HV-contacts can be measured with only one sensor. Thermal overloading in the plug-in system or wire harness (“derating”) can be detected early. In addition, mechanical damage due to aging, which can, for example, result in greater thermal stress, can be detected.

According to a first aspect, the present disclosure provides a high-voltage contact system with two high-voltage contacts that are configured to produce a high-voltage connection in a battery-powered vehicle; a temperature sensor that is arranged between the two high-voltage contacts and is configured to record a temperature based on the temperatures of both of the two high-voltage contacts; and a thermally-conductive, electrically-insulating element embedded in the temperature sensor that makes contact with the two high-voltage contacts, the thermally-conductive, electrically-insulating element thereby forming a thermal bridge between the two HV-contacts and the temperature sensor, so that the temperature sensor can record the temperature based on the temperatures of both of the high-voltage contacts.

The two high-voltage contacts can, for example, form a high-voltage connection with a traction unit or a drive unit of the battery-powered vehicle, or they can form a high-voltage connection with a high-voltage battery of the battery-powered vehicle, or with a charging socket, or with HV-auxiliary consumers of the battery-powered vehicle.

With a high-voltage contact system of this kind, the temperature of the contact poles can be monitored in a manner that is cost-efficient and saves installation space. It has been demonstrated that with the use of a single temperature sensor, a second such sensor can be dispensed with, which reduces installation space and cost. With the single temperature sensor, the temperatures of both high-voltage contacts can be monitored simultaneously. With the thermal connection of the sensor via the thermally-conductive, electrically-insulating element to the two HV-contacts, the current temperatures of both HV-contacts can be recorded simultaneously by the temperature sensor. Then, the temperature sensor does not record both temperatures separately, but rather as a single temperature, which provides information on the thermal status of both HV-contacts.

According to an example of the high-voltage contact system, the temperature sensor is arranged centrally between the two high-voltage contacts, so that it can record a temperature that lies between the temperature of the first of the two high-voltage contacts and the temperature of a second of the two high-voltage contacts.

Here, the temperature recorded by the temperature sensor can, for example, be a temperature that lies between the temperature of the first HV-contact and the temperature of the second HV-contact. It can, for example, be a mean value of the two temperatures, or a weighted mean value where a higher temperature is weighted more strongly than a lower temperature.

According to an example of the high-voltage contact system, the thermally conductive, electrically-insulating element is an elastomer, in particular a silicon, and the contact between the thermally-conductive, electrically-insulating element and the two high-voltage contacts is brought about by overmolding of the elastomer over the two high-voltage contacts or insertion of the two high-voltage contacts into the elastomer.

With an elastomer of this kind, a good heat transfer from the HV-contacts to the elastomer can be achieved, because due to the overmolding or insertion, the elastomer adheres directly to the HV-contacts.

According to an example of the high-voltage system, the overmolding or insertion forms an airgap-free thermal bridge between the thermally conductive, electrically-insulating element and the two high-voltage contacts.

With overmolding or insert-molding of this kind, good heat conductivity can be achieved, as no airgaps form. No gap-filler is thus needed.

According to an example of the high-voltage contact system, the temperature sensor is inserted in the elastomer or overmolded with the elastomer.

This achieves the technical advantage that the temperature sensor abuts directly on the elastomer, so that the heat is transmitted via the contact surface between elastomer and temperature sensor, and there is no thermally-insulating material such as air between them.

According to an example of the high-voltage contact system, the high-voltage contact system includes a second electrically-insulating element, which is arranged between the two high-voltage contacts and is configured to electrically insulate the two high-voltage contacts from each other, the thermally-conductive, electrically-insulating element being formed as a soft component, and the second electrically-insulating element being formed as a hard component.

The hard component provides the desired mechanical stability, whereas the soft component provides good heat transfer from the HV-contacts to the temperature sensor.

According to an example of the high-voltage contact system, the thermally conductive, electrically-insulating element is formed as a 2K injection-molded soft component and the second electrically-insulating element is formed as a 2K injection-molded hard component.

The contact system can thus be efficiently manufactured using 2K injection molding, with which the temperature sensor is embedded in the soft component or overmolded by it.

According to an example of the high-voltage contact system, each of the two high-voltage contacts has a notch, and the thermally conductive, electrically-insulating element has two tongues, which are pressed into the corresponding notches in the high-voltage, the tongues forming, respectively, airgap-free connections with the high-voltage contacts.

With the notches, good mechanical stability is achieved for the fixation of the electrically-insulating element to the HV-contacts. In addition, the airgap-free connections with the HV-contacts provides good heat transmission.

According to an example of the high-voltage contact system, the thermally-conductive, electrically-insulating element has a third tongue that is arranged between the two high-voltage contacts and is attached to the second insulating element, the third tongue thereby forming an airgap-free connection with the two high-voltage contacts.

Via the third tongue, the thermally-conductive, electrically-insulating element is securely attached to the second insulating element, for example via a notch in the second insulating element. The temperature sensor can be located in the thermally conductive, electrically-insulating element near, or also inside, the third tongue, so a distance to the two HV-contacts is reduced, and heat transmission between the two HV-contacts and the temperature sensor is improved.

According to an example of the high-voltage contact system, the thermally conductive, electrically-insulating element is formed as a hard component and forms the thermal bridge between the two high-voltage contacts and the temperature sensor via a gap filler material between the thermally-conductive, electrically-insulating element and the two high-voltage contacts and/or between the thermally-conductive, electrically-insulating element and the temperature sensor.

No soft components are needed in an example of this kind. Instead, the thermally conductive, electrically-insulating element and the second insulating element are configured as hard components, in particular as a single hard component in which the temperature sensor is embedded. In order to improve the heat transmission between the HV-contacts and the temperature sensor, gap-filler materials can be used, which fill in a potential airgap between HV-contacts and hard component, or between hard component and temperature sensor, and in this way improve the thermal transfer.

In this disclosure, HV-contact and HV-batteries are described. If high voltage vehicles are to be driven with performance that is acceptable to the vehicle owner, it will be desired for the electric engines to be operated with very high currents and voltages. Motor-vehicle systems and components that are operated above 25 V AC or 60 V DC are called high-voltage (HV)-systems or HV vehicles. Voltages of more than 25 V alternating current (AC) or more than 60 V direct current may have hazardous effects on the human body. In the current HV vehicles, the voltages of the HV-system are between 100 V and 800 V (DC). The high-voltage systems in most current electric automobiles operate with a voltage level of around 400 Volts.

This disclosure describes hard components and soft components that are usually produced by injection molding, in particular 2-component (2K) injection molding. With 2K injection molding, the first component is usually the robust, form-giving components. That is why these are also described as hard components. The materials used are, for example, PP (polypropylene), PS (polystyrene), PC (polycarbonate)+acrylonitrile butadiene styrene copolymer (ABS), polyamide (PA) or polybutylene terephthalate (PBT). The second component is usually soft and elastic. It is therefore also termed a soft component. Gaskets, as soft components, are often injected by 2K injection-molding directly onto a support part. Examples of the material used are thermoplastic elastomer (TPE), or ethylene propylene diene monomer (EPDM), or liquid silicon rubber (LSR).

In this disclosure, injection and overmolding techniques are described. In this disclosure, a connection technology is termed an injection technique with which an elastic element or elastomer is pressed or molded over a solid second element, such as, for example, the HV-contact, in order to create a tight connection between the two elements. In the process, an opening or notch or hole in the elastic element is pressed over a corresponding elevation, for example a tongue or a pin of the second element, producing a tight heat-conductive connection between the two elements. The diagonal of the cross section of the pin of the second element is greater than the diameter of the hole in the elastic element. Pressing the pin-edge into the hole in the elastic element produces a thermally-conductive connection characterized by high reliability and longevity. The crimp that occurs during press-fitting can be accommodated by the deformation of the hole or the deformation of the pin.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of a contact system with temperature sensor for measuring the temperature of the two HV-contacts according to the present disclosure;

FIG. 2 is a cross-sectional view of the contact system that illustrates the temperature-measurement concept according to the present disclosure; and

FIG. 3 is a cross-sectional detail view of the contact system that illustrates the temperature-measurement connection according to the present disclosure.

The figures are only schematic representations and serve solely to explain the present disclosure. Identical elements or those that produce the same effects are assigned the same reference signs throughout.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The aspects and examples will be described with reference to the drawings, wherein the same reference signs generally refer to the same elements. In the following description, for the purpose of explanation, numerous specific details will be presented in order to provide an in-depth understanding of one or multiple aspects of the present disclosure. However, to a person skilled in the art, it can be obvious that one or multiple aspects or examples could be executed with a lesser degree of the detail in question. In other instances, known structures and elements are shown in schematic form in order to facilitate the description of one or multiple aspects or examples. It is clear that other examples could be used, and structural or logical changes made without departing from the concept of the present disclosure.

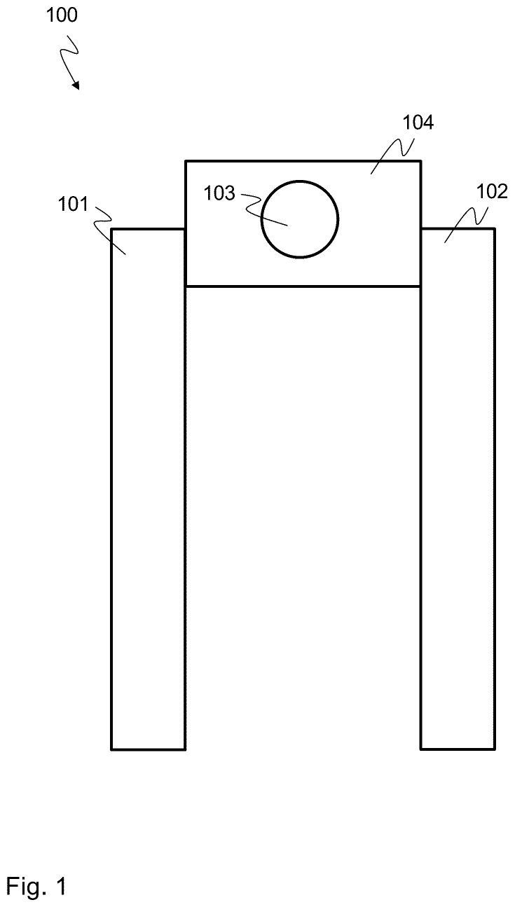

FIG. 1 shows a schematic representation of the contact system 100 with temperature sensor for measuring the temperature of the two HV-contacts.

The high-voltage contact system 100 comprises two high-voltage contacts 101, 102, a temperature sensor 103, and a thermally-conductive, electrically-insulating element 104.

The two high-voltage contacts 101, 102 are configured to form a high voltage connection in a battery-powered vehicle.

The two high-voltage contacts 101, 102 can, in particular, form a high voltage connection with a traction unit or drive unit of a battery-powered vehicle. Furthermore, they can form a high-voltage connection with a high-voltage battery of the battery-powered vehicle, or with a charging socket, or with HV auxiliary consumers of the battery-powered vehicle.

The temperature sensor 103 is arranged between the two high-voltage contacts 101, 102 and is designed or configured to record a temperature based on the temperatures of both of the high-voltage contacts 101, 102.

The thermally-conductive, electrically-insulating element 104 encapsulates the temperature sensor 103 and contacts the two high-voltage contacts 101, 102. Here the thermally-conductive, electrically-insulating element 104 forms a thermal bridge between the two HV-contacts 101, 102 and the temperature sensor 103, so that the temperature sensor 103 can record the temperature based on the temperatures of both high-voltage contacts 101, 102.

For example, here, the temperature sensor 103 can record a temperature as a thermal notification of the temperatures of both HV-contacts 101, 102.

The thermally conductive, electrically-insulating element 104 can, for example, be an electrically-insulating elastomer, such as, for example, silicon, which, in order to improve thermal conductivity, in enhanced with additives, such as, for example, ceramics, for example aluminum oxide or boron nitride, or others. These additives, for example embedded as μ-particles in silicon, improve heat transfer in the thermally-conductive, electrically-insulating element 104.

The two high-voltage contacts 101, 102 can connect the HV-battery to an electric engine of the battery-powered vehicle in order to drive the vehicle, or also to a charging infrastructure for charging the HV-battery.

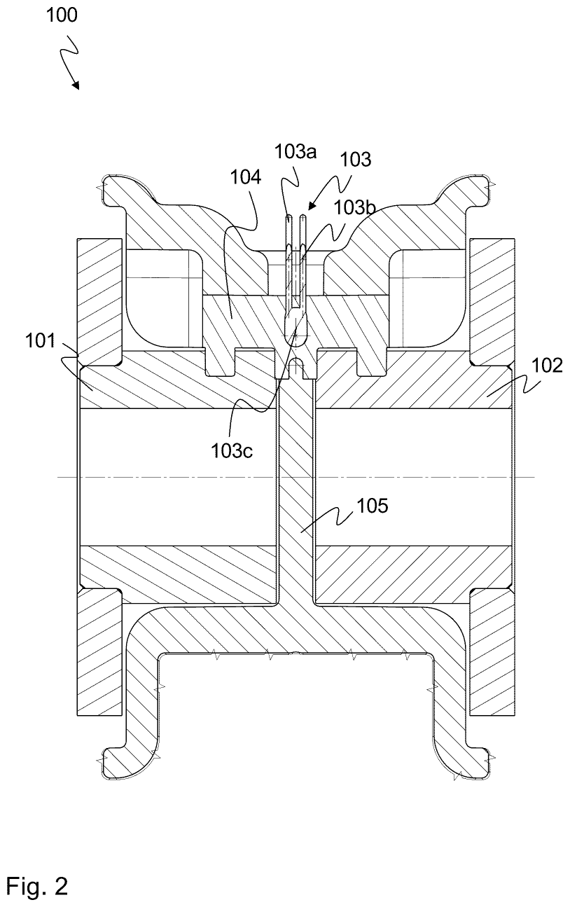

The temperature sensor 103 comprises, for example, a sensor capsule 103c and two connecting wires 103a, 103b, as shown in FIG. 2.

The temperature sensor can be configured, for example, as an NTC, PTC, or platinum sensor, in which the resistance value of the material of the sensor capsule 103c changes with the temperature. This change in temperature can be communicated via the two connecting wires, transmitted, for example, to a controller.

In one example, the sensor capsule is overmolded with silicon (soft component), which is the thermally-conductive, electrically-insulating element 104, the capsule being held in position in this way. The silicon comes into contact with both poles or HV-contacts 101, 102 through the overmolding. Heat transfer takes place from both contacts 101, 102 via the thermally conductive silicon or the thermally-conductive, electrically-insulating element 104 to the temperature sensor 103.

FIG. 2 shows a 2D cross-sectional representation of the contact system 100 to illustrate the temperature-measurement concept.

As already schematically represented above in FIG. 1, the high-voltage contact system 100 comprises two high-voltage contacts 101, 102 which are configured to form a high-voltage connection in a battery-powered vehicle; a temperature sensor 103 that is arranged between the two high-voltage contacts 101, 102 and is configured to record a temperature based on temperatures from both of the high-voltage contacts 101, 102; and a thermally-conductive, electrically-insulating element 104 that encapsulates the temperature sensor 103 and contacts the two high-voltage contacts 101, 102.

The thermally-conductive, electrically-insulating element 104 forms a thermal bridge between the two HV-contacts 101, 102 and the temperature sensor 103, so that the temperature sensor 103 can record the temperature based on the temperatures of the two high-voltage contacts 101, 102.

As can be seen in the representation in FIG. 2, the temperature sensor 103 is arranged centrally between the two high-voltage contacts 101, 102, so that it can record a temperature that lies between the temperature of a first 101 of the two high-voltage contacts 101, 102 and the temperature of a second 102 of the two high-voltage contacts 101, 102, for example a mean value or a weighted mean value of the two temperatures of the HV-contacts 101, 102.

As already described above, the thermally-conductive, heat-insulating element 104 can be an elastomer, in particular a silicon. The contact between the thermally-conductive, heat-insulating element 104 and the two high-voltage contacts 101, 102 can be formed by an overmolding of the elastomer over the two high-voltage contacts 101, 102 or by injecting the two high-voltage contacts 101, 102 into the elastomer.

In particular, such overmolding or injection molding can form an airgap-free thermal bridge between the thermally-conductive, electrically-insulating element 104 and the two high-voltage contacts 101, 102.

The temperature sensor 103 can, for example, be injected into the elastomer or thermally-conductive, electrically-insulating element 104 or overmolded with the elastomer or thermally-conductive, electrically-insulating element 104.

As shown additionally in FIG. 2, the high-voltage contact system 100 can include a second electrically-insulating element 105 that is arranged between the two high-voltage contacts 101, 102 and is configured to electrically insulate the two high-voltage contacts 101, 102 from each other. The thermally-conductive, electrically-insulating element 104 can, in one example, be formed as a soft component, and the second thermally-conductive, electrically-insulating element 105 can be formed as a hard component.

For example, the electrically-insulating element 104 can be formed as a 2K injection-molded soft component and the second electrically-insulating element as a 2K injection-molded hard component.

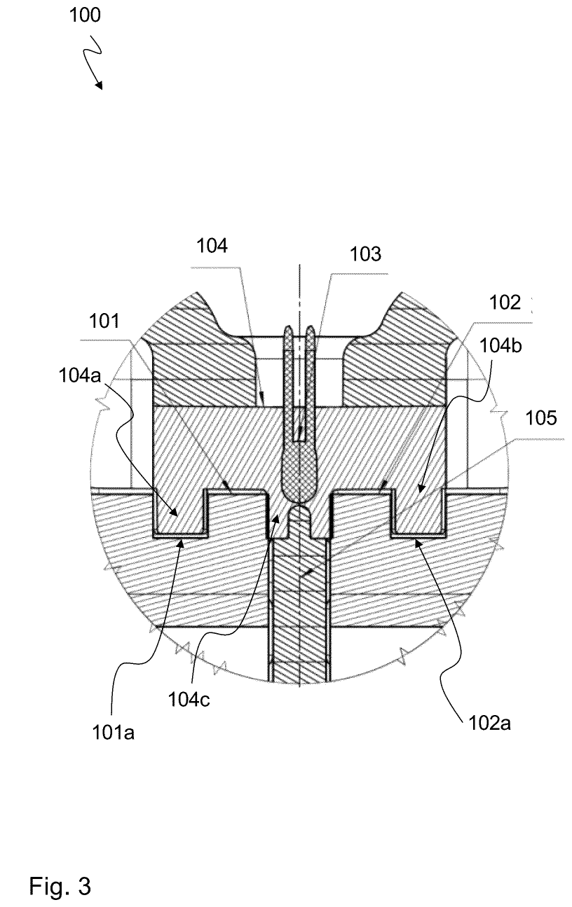

FIG. 3 shows a 2D section of the contact system 100 to illustrate the temperature-measurement connection.

The 2D section is a more detailed representation of the thermally conductive, electrically-insulating element 104 and its contact surfaces with both of the HV-contacts 101, 102. as well as said element's contact surfaces with the temperature sensor 103.

As can be seen in FIG. 3, each of the two high-voltage contacts 101, 102 has a notch 101a, 102b. The thermally-conductive, electrically-insulating element 104 can have two tongues 104a, 104b that are injected into the corresponding notches 101a, 102a of the high-voltage contacts 101, 102 and in each instance form airgap-free connections with the high-voltage contacts 101, 102. Due to the airgap-free connections, there is particularly good heat transfer via these contact surfaces.

In the representation in FIG. 3, the thermally-conductive, electrically insulating element 104 can have a third tongue 104c that is arranged between the two high-voltage contacts 101, 102 and is attached to the second insulating element 105, for example as a 2K injection-molded connection. The third tongue 104c can form an airgap-free connection with the two high-voltage contacts 101, 102. This airgap-free connection brings about a particularly good heat transfer via the contact surfaces between the HV-contacts 101, 102 and the third tongue 104c of the thermally-conductive, electrically-insulating element 104.

In one example, the thermally-conductive, electrically-insulating element 104 can also be formed as a hard component, and the thermal bridge between the two high-voltage contacts 101, 102 and the temperature sensor 103 can be formed by means of a gap-filler material between the thermally-conductive, electrically-insulating element 104 and the two high-voltage contacts 101, 102, and/or between the thermally-conductive, electrically-insulating element 104 and the temperature sensor 103.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A high-voltage contact system comprising:
two high-voltage contacts that are configured to form a high-voltage connection in a battery-operated vehicle;
a temperature sensor arranged between the two high-voltage contacts and configured to record a temperature based on temperatures of both of the two high-voltage contacts, and
a thermally-conductive, electrically-insulating element that is embedded in the temperature sensor and contacts the two high-voltage contacts, the thermally-conductive, electrically-insulating element configured to form a thermal bridge between the two high-voltage contacts and the temperature sensor, wherein at least one of:
the thermally-conductive, electrically-insulating element is an elastomer, and contact between the thermally-conductive, electrically-insulating element and the two high-voltage contacts is formed by an overmolding of the elastomer over the two high-voltage contacts or an injection molding of the two high-voltage contacts into the elastomer, with the overmolding or injection molding forming an airgap-free thermal bridge between the thermally-conductive, electrically-insulating element and the two high-voltage contacts; and
the thermally-conductive, electrically-insulating element is an elastomer, and the temperature sensor is encapsulated by the elastomer, with an airgap-free thermal bridge formed between the thermally-conductive, electrically-insulating element and the two high-voltage contacts, each of the two high-voltage contacts includes a notch, and the thermally-conductive, electrically-insulating element has two tongues which are pressed into corresponding notches of the two high-voltage contacts to form the airgap-free connections with the two high-voltage contacts.

2. The high-voltage contact system according to claim 1, wherein the temperature sensor is arranged centrally between the two high-voltage contacts, and the temperature sensor is configured to record a temperature that lies between the temperature of a first contact of the two high-voltage contacts and the temperature of a second contact of the two high-voltage contacts.

3. The high-voltage contact system according to claim 1, wherein the thermally-conductive, electrically-insulating element is a silicon.

4. The high-voltage contact system according to claim 1, wherein the temperature sensor is inserted in the elastomer.

5. The high-voltage contact system according to claim 1, wherein the thermally-conductive, electrically-insulating element includes a third tongue that is arranged between the two high-voltage contacts and is attached to the thermally-conductive, electrically-insulating element,
wherein the third tongue forms an airgap-free connection with the two high-voltage contacts.

6. The high-voltage contact system according to claim 1, wherein the thermally-conductive, electrically-insulating element is configured as a hard component, and forms the thermal bridge between the two high-voltage contacts and the temperature sensor via a gap filler material between at least one of the thermally-conductive, electrically-insulating element and the two high-voltage contacts, and the thermally-conductive, electrically-insulating element and the temperature sensor.

7. A high-voltage contact system comprising:
two high-voltage contacts configured to form a high-voltage connection in a battery-operated vehicle;
a temperature sensor arranged between the two high-voltage contacts and configured to record a temperature based on temperatures of both of the two high-voltage contacts; and
a thermally-conductive, electrically-insulating element that is embedded in the temperature sensor and contacts both of the two high-voltage contacts, the thermally-conductive, electrically-insulating element is configured to form a thermal bridge between the two high-voltage contacts and the temperature sensor, wherein at least one of:
a second electrically-insulating element is arranged between the two high-voltage contacts and is configured to electrically insulate the two high-voltage contacts from each other, and the thermally-conductive, electrically-insulating element is formed as a 2K injection-molding soft component, and the second electrically-insulating element is formed as a 2K injection-molding hard component; and
the thermally-conductive, electrically-insulating element is configured as a hard component and forms the thermal bridge between the two high-voltage contacts and the temperature sensor via a gap filler material between at least one of the thermally-conductive, electrically-insulating element and the two high-voltage contacts, and the thermally-conductive, electrically-insulating element and the temperature sensor.

8. The high-voltage contact system according to claim 7, wherein each of the two high-voltage contacts includes a notch and the thermally-conductive, electrically-insulating element has two tongues, which are pressed into corresponding notches in the two high-voltage contacts and to form airgap-free connections with the two high-voltage contacts.

9. The high-voltage contact system according to claim 8, wherein the thermally-conductive, electrically-insulating element includes a third tongue that is arranged between the two high-voltage contacts and is attached to the second insulating element, and the third tongue forms an airgap-free connection with the two high-voltage contacts.
